(19) United States
(12) Patent Application Publication
(10) Pub. No.: US 2020/0390067 A1
(43) Pub. Date: Dec. 17, 2020

(54) PET CLOTHING FOR BODY CORRECTION

(71) Applicant: Dr. PETSTAR, Goyang-si, Gyeonggi-do (KR)

(72) Inventor: Min Ji KIM, Goyang-si, Gyeonggido (KR)

(73) Assignee: Dr. PETSTAR, Goyang-si, Gyeonggi-do (KR)

(21) Appl. No.: 16/090,275

(22) PCT Filed: Feb. 27, 2017
(86) PCT No.: PCT/KR2017/002161

§ 371 Date: Oct. 1, 2018

(30) Foreign Application Priority Data
Apr. 8, 2016 (KR) 10-2016-0043677
Apr. 8, 2016 (KR) 10-2016-0043680

(51) Int. Cl. A01K 29/00; A01K 13/00

(52) U.S. Cl. CPC A01K 29/00; A01K 13/006

(57) ABSTRACT

A pet clothing for body correction that a pet wears to protect and correct the pet's spine, hip joints and kneepan from dislocation, the pet clothing for body correction, which is made of elastic materials and is divided into several parts with different degrees of elasticity, includes: a top for surrounding the pet's back and abdomen; and a bottom for surrounding the pet's hind legs.

### TECHNICAL FIELD

The present invention relates to a pet clothing for body correction, and more particularly, to a pet clothing for body correction that a pet wears to protect the pet's spine, hip joints and kneepan and to correct dislocation of the pet's spine, hip joints and kneepan.

### BACKGROUND ART

Recently, with an increase of the level of income and the increasing tendency of nuclear families, the number of families raising pets to avoid monotony is rapidly increasing. Because such families treat the pets like one of their family members or like their own child and most of them raise pets indoors, they must exercise their pets on a regular cycle or walk or exercise the pets while pet owners take a walk together with the pets. However, with today's busy lifestyles, the pet owners cannot afford to do that. So, because pets live in limited areas, the pets are restricted in movement and it may cause obesity and problems in the pet's spine.

Moreover, because the floor or floor paper laid in an apartment or a house is slippery, the pet's legs may be bent or the pet's kneepan may be dislocated while the pet slips, and the pet may try to stand like a man or the pet's hip joints may be dislocated due to obesity.

That is, pets may take bad postures, become obese, and obtain dislocation in their knees and hip joints while living in limited areas.

### Disclosure

### Technical Problem

Accordingly, the present invention has been made in view of the above-mentioned problems occurring in the prior art, and it is an object of the present invention to provide a pet clothing for body correction, which includes spine protecting parts disposed at an upper portion of the pet clothing for body correction to protect a pet's spine and spine fixing parts disposed at the upper portion of the pet clothing to fix the spine protecting parts when the pet wears the pet clothing for body correction, wherein the spine protecting parts and the spine fixing parts have different degrees of elasticity from other parts, thereby protecting the pet's spine by pressing and fixing the pet's spine getting strain due to obesity.

It is another object of the present invention to provide a pet clothing for body correction, which includes knee protecting parts and hip joint parts formed at a lower portion of the pet clothing and having different degrees of elasticity from other parts, thereby protecting the pet's knees and hip joints by pressing and fixing the pet's knees and hip joints.

However, the present invention is not restricted to the above mentioned objects, and other objects of the present invention will be apparent to those skilled in the art from the following detailed description of the preferred embodiments of the invention.

### Technical Solution

To accomplish the above object, according to the present invention, a pet clothing for body correction is woven by a seamless method, is made of elastic materials, and is divided into various parts with different degrees of elasticity from one another. So, a method for manufacturing the pet clothing for body correction comprises the steps of: weaving an intermediate product, which is seamless, is formed in a cylindrical shape and is woven integrally; cutting the intermediate product into several parts; and sewing the cut parts.

To accomplish the above object, there is provided a pet clothing for body correction that a pet wears to protect and correct the pet's spine, hip joints and kneepan from dislocation. The pet clothing for body correction, which is made of elastic materials and is divided into several parts with different degrees of elasticity, includes: a top for surrounding the pet's back and abdomen; and a bottom for surrounding the pet's hind legs.

Moreover, the top for surrounding the pet's back and abdomen includes: a front part for surrounding the pet's back; and a rear part for surrounding the pet's abdomen. When the pet wears the clothing, the front part includes: spine protecting parts formed at the right and the left on the basis of the spine in order to protect the pet's spine; and spine fixing parts formed adjacent to the spine protecting parts to pull the spine protecting parts to both sides and fix the spine protecting parts. The other parts of the clothing excluding the spine protecting parts and the spine fixing parts are different in the degree of elasticity from the spine protecting parts and the spine fixing parts.

That is, the spine protecting parts and the spine fixing parts have the same degree of elasticity, but the other parts of the clothing are weaker in the degree of elasticity than the spine protecting parts and the spine fixing parts.

Moreover, the top further includes: a cardiac massage part formed on the rear part, namely, near the left side where the pet's heart is located, to protect the pet's heart; and a fitting part formed to allow the pet to put the forelegs into the fitting part, wherein the cardiac massage part is formed integrally and has a protrusion part to provide a cardiac massage function.

Furthermore, the top further includes: an abdomen massage part formed on the rear part to protect the pet's abdomen, wherein the abdomen massage part is formed integrally, and has a protrusion part to provide an abdomen massage function.

Additionally, the spine protecting parts are formed at the right and the left to be parallel with the pet's spine and to be spaced apart from each other at regular intervals on the basis of the pet's spine. The spine fixing parts extend from predetermined positions of the spine protecting parts to the rear part, and the fitting part is formed at the rear part to have a shape for allowing the pet to put the forelegs thereinto.

In this instance, other parts of the clothing excluding the spine protecting parts and the spine fixing parts are weaker in the degree of elasticity than the spine protecting parts and the spine fixing parts.

In addition, the predetermined positions where the spine fixing parts are formed are located at an upper end portion and a lower end portion on the basis of the central position in a longitudinal direction of the spine protecting parts.

Moreover, the bottom for surrounding the pet's hind legs includes: a tail part having an opening for allowing the pet to insert the tail thereinto; and knee protecting parts for protecting the knee ligament by surrounding the knees of the hind legs of the pet, wherein other parts of the pet clothing excluding the knee protecting parts have different degrees of elasticity.

Furthermore, the bottom for surrounding the pet's hind legs comprises: a tail part having an opening for passing the pet's tail therethrough; knee protecting parts surrounding the knees of the hind legs of the pet to protect the knee ligament; and hip joint parts for surrounding the hip joints in order to protect the pet's hip joints, wherein other parts of the pet clothing excluding the knee protecting parts and the hip joint parts have different degrees of elasticity.

Additionally, the pet clothing for body correction further includes: a fixing part caught and fixed to the pet's waist in order to prevent slip down of the clothing, and the fixing part has elasticity.

In this instance, other parts of the clothing excluding the knee protecting parts and the hip joint parts have different degrees of elasticity.

Moreover, the knee protecting parts are formed in a diamond shape to surround the knees of the hind legs of the pet, and when one of the knee protection parts is spread, an X-shape is connected to form the diamond shape at the center. When a user pulls the diamond shape to both sides, the knee protecting parts press and fix the pet's knees.

Furthermore, the knee protecting parts have a plurality of straight lines to surround the knees from knee parts of the hind legs, the straight lines are formed in a vertical direction or a horizontal direction, and when the user pulls the straight line shape to both sides, it presses and fixes the knees.

Additionally, the hip joint parts are formed at portions of the clothing corresponding to the pet's hip joints in an X shape.

In this instance, the knee protecting parts and the hip joint parts have the same degree of elasticity, and other parts of the clothing excluding the knee protecting parts and the hip joint parts are weaker in the degree of elasticity than the knee protecting parts and the hip joint parts.

The above and other objects, features and advantages of the present invention will be apparent from the following detailed description of the preferred embodiments of the invention in conjunction with the accompanying drawings.

Particular terms may be defined to describe the invention in the best manner. Accordingly, the meaning of specific terms or words used in the specification and the claims should not be limited to the literal or commonly employed sense, but should be construed in accordance with the spirit of the invention as described herein.

### Advantageous Effects

As described above, the pet clothing for body correction according to the present invention can maintain the pet's spine by pressing and fixing the pet's spine since including the spine protecting parts and the spine fixing parts, which are woven using elastic fiber materials with different degrees of elasticity to protect the pet's spine the pet clothing for body correction, prevent and correct dislocation of the kneepan since the knee protecting parts for protecting the knees press the pet's knees, and press and fix the hip joints. Therefore, when the pet wears the pet clothing for body correction according to the present invention, the pet clothing can correct the pet's posture and protect the pet's spine, knees and hip joints even though the pet lives indoors.

### DESCRIPTION OF DRAWINGS

FIG. 1 is a plan view showing a front part of a top of a pet clothing for body correction according to an embodiment of the present invention.

FIG. 2 is a plant view showing a rear part of the top of the pet clothing for body correction.

FIG. 3 is a plan view showing a development figure of the top of the pet clothing for body correction.

FIG. 4 is a perspective view showing a state that a pet wears the top of the pet clothing for body correction.

FIG. 5 is a photograph of the pet clothing for body correction.

FIG. 6 is a plan view showing a bottom of the pet clothing for body correction according to an embodiment of the present invention.

FIG. 7 is a plan view showing a bottom of the pet clothing for body correction according to another embodiment of the present invention.

FIG. 8 is a plant view showing a bottom of the pet clothing for body correction according to a further embodiment of the present invention.

FIG. 9 is a plan view showing a bottom of the pet clothing for body correction according to another embodiment of the present invention.

FIG. 10 is a plan view showing a development figure of the bottom of the pet clothing for body correction according to the embodiment of the present invention.

FIG. 11 is a plan view showing a development figure of the bottom of the pet clothing for body correction according to the embodiment of the present invention.

FIG. 12 is a perspective view showing a state that a pet wears the bottom of the pet clothing for body correction according to the embodiment of the present invention.

### MODE FOR INVENTION

Advantages and features of the present invention, and method to achieve them of the present invention will be obvious with reference to embodiments along with the accompanying drawings which are described below. Meanwhile, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. In the detailed description, the same reference numbers of the drawings refer to the same or equivalent parts of the present invention.

Hereinafter, a pet clothing for body correction according to preferred embodiments of the present invention will be described with reference to the drawings.

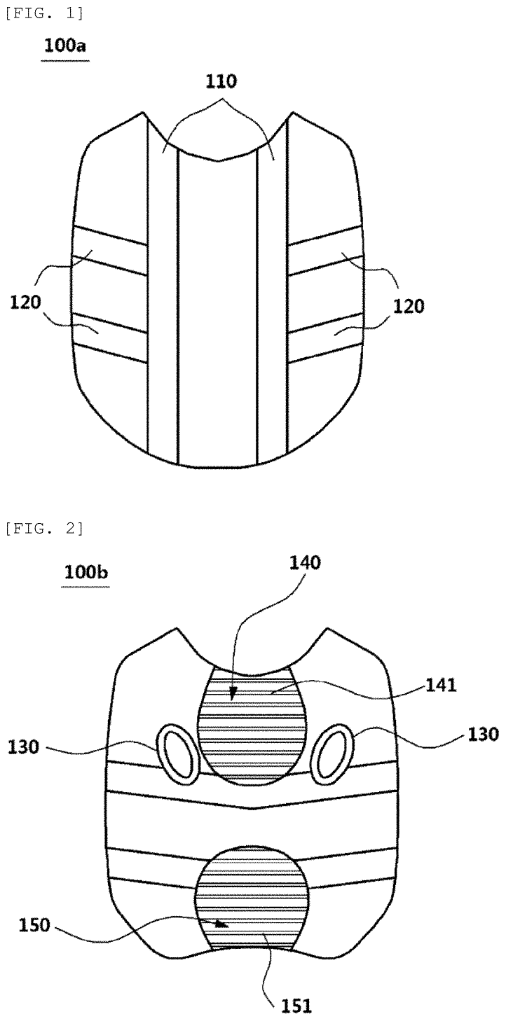

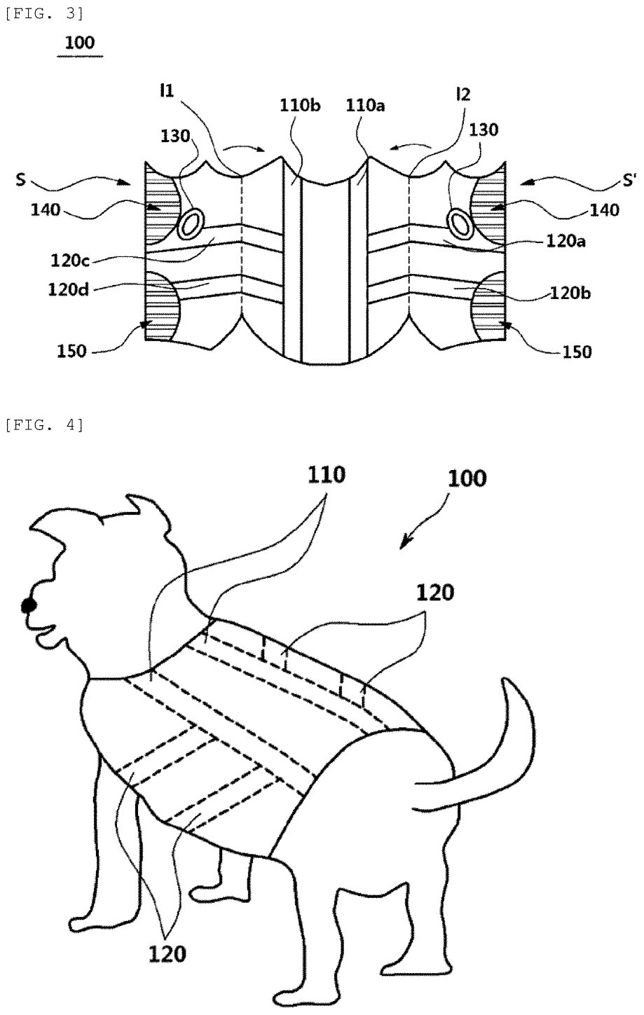

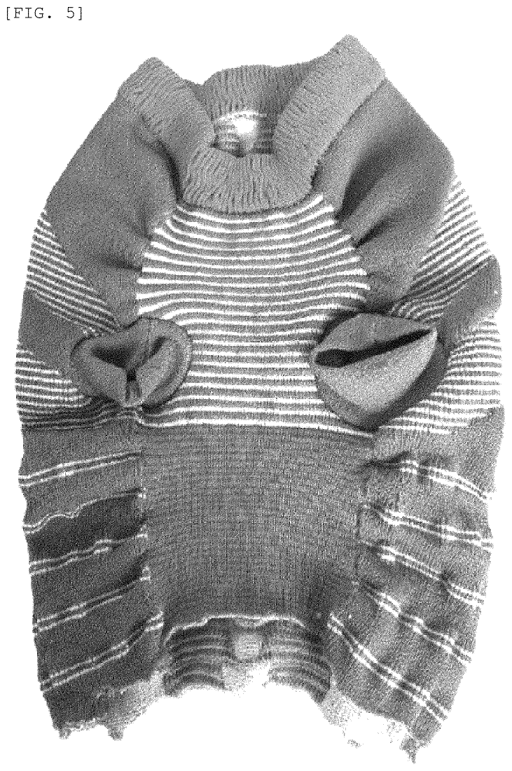

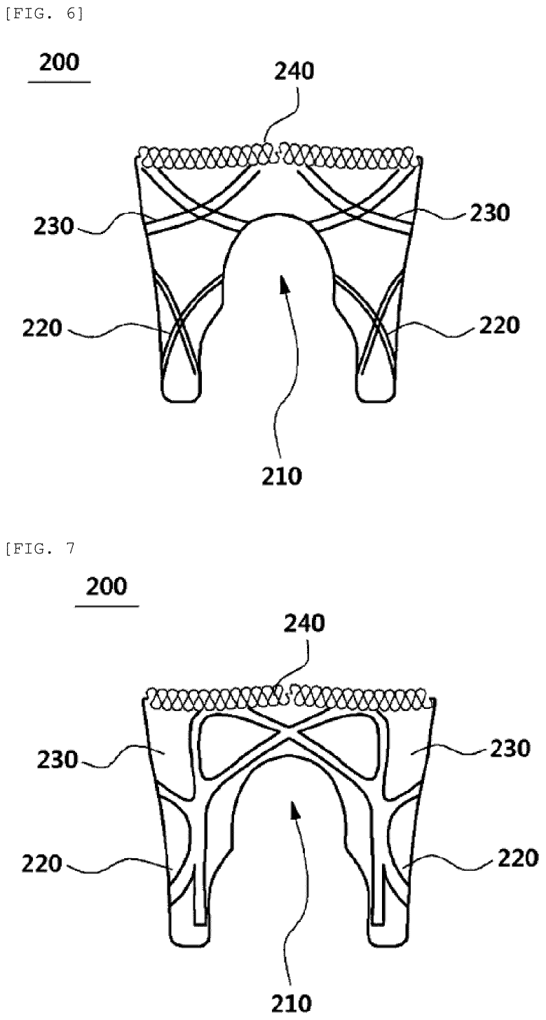

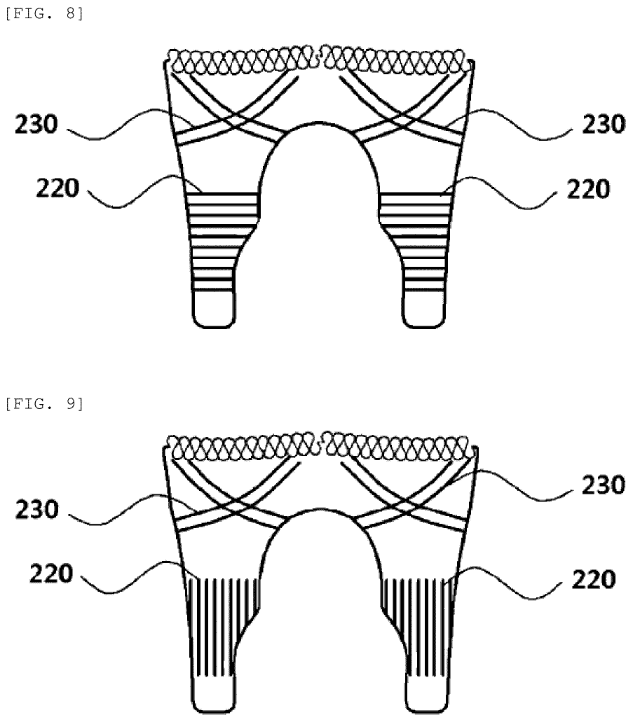

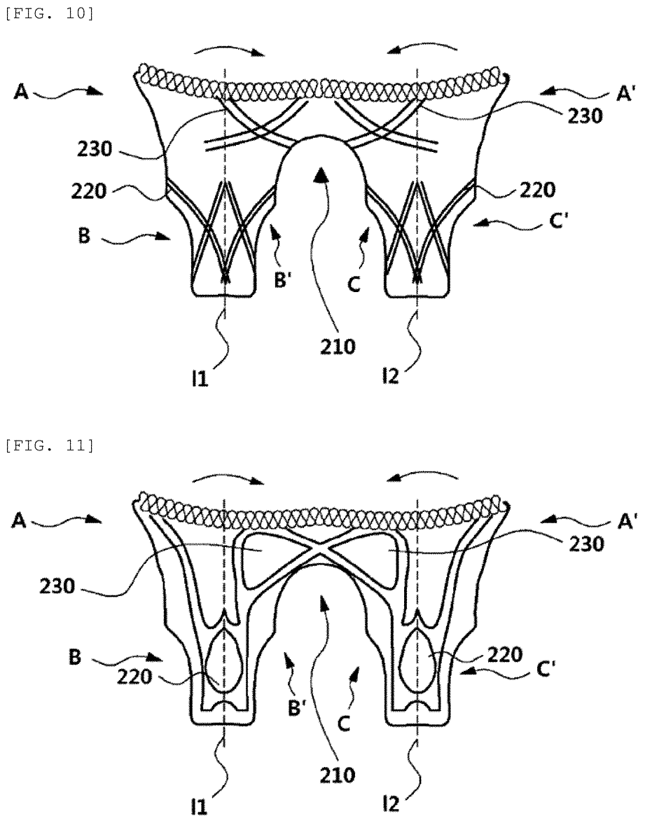

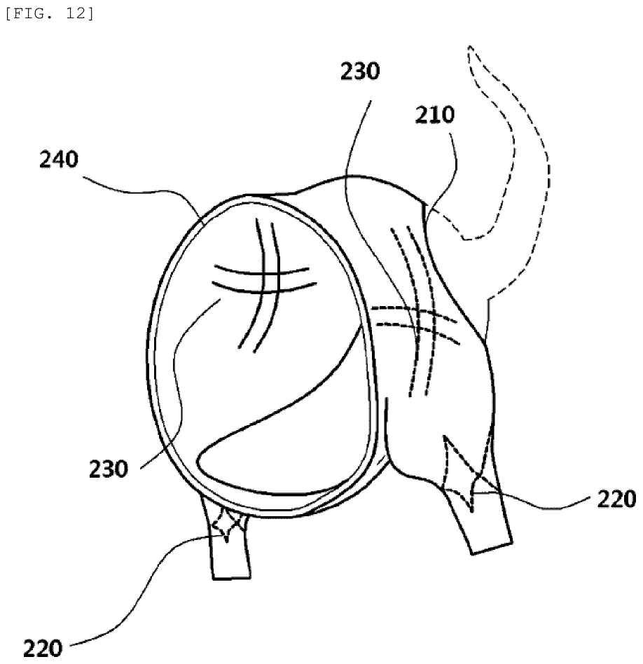

FIG. 1 is a plan view showing a front part of a top of a pet clothing for body correction according to an embodiment of the present invention, FIG. 2 is a plant view showing a rear part of the top of the pet clothing for body correction, FIG. 3 is a plan view showing a development figure of the top of the pet clothing for body correction, FIG. 4 is a perspective view showing a state that a pet wears the top of the pet clothing for body correction, FIG. 5 is a photograph of the pet clothing for body correction, FIG. 6 is a plan view showing a bottom of the pet clothing for body correction according to an embodiment of the present invention, FIG. 7 is a plan view showing a bottom of the pet clothing for body correction according to another embodiment of the present invention, FIG. 8 is a plant view showing a bottom of the pet clothing for body correction according to a further embodiment of the present invention, FIG. 9 is a plan view showing a bottom of the pet clothing for body correction according to another embodiment of the present invention, FIG. 10 is a plan view showing a development figure of the bottom of the pet clothing for body correction according to the embodiment of the present invention, FIG. 11 is a plan view showing a development figure of the bottom of the pet clothing for body correction according to the embodiment of the present invention, and FIG. 12 is a perspective view showing a state that a pet wears the bottom of the pet clothing for body correction according to the embodiment of the present invention.

The pet clothing for body correction according to the present invention is a clothing for pets to protect the pet's spine, hip joints and kneepan and correct dislocation of the pet's spine, hip joints and kneepan.

The pet clothing for body correction is made of elastic materials, and is divided into several parts with different degrees of elasticity, and includes a top 100 for surrounding a pet's back and stomach and a bottom 200 for surrounding the pet's hind legs.

Referring to FIGS. 1 and 2, the top 10 for surrounding the pet's back and stomach includes a front part 100a for surrounding the pet's back and a rear part 100a for surrounding the pet's stomach when the pet wears the pet clothing.

FIGS. 1 and 2 illustrate the front part 100a and the rear part 100a of the inner side of the top.

First, when the pet wears the pet clothing, the front part 100a includes spine protecting parts 110 and spine fixing parts 120.

When the pet wears the top of the pet clothing for body correction, the spine protecting part 110 has the same width at the right and left on the basis of the pet's spine, is formed in parallel with the pet's spine, and has elasticity to hold the posture so that the pet's spine is not bent.

The spine fixing parts 120 are formed adjacent to the spine protecting parts 110 mounted at the right and left of the clothing so as to press and fix the spine protecting parts 110 not to be moved, and have elasticity to fix the spine protecting parts.

Moreover, two or more spine fixing parts 120 are formed at the right and left sides to be adjacent to the spine protecting parts 110.

In this instance, the spine protecting parts 110 and the spine fixing parts 120 have different degrees of elasticity from other parts.

Furthermore, the spine fixing parts 120 extends from predetermined positions of the spine protecting parts 110 to the rear side, and in this instance, the predetermined positions are formed at an upper portion and a lower portion from a middle point of the spine protecting parts 110.

In this instance, the positions of the spine fixing parts 120 are not restricted, and may be formed at any positions.

When the pet wears the pet clothing for body correction, the rear part 100a includes fitting parts 130, a cardiac massage part 140, and the spine fixing parts 120.

The spine fixing parts 120 extends from the front part 100a of the pet clothing to the rear part 100a.

The fitting parts 130 allow the pet to put its forelegs thereinto. The form of the fitting parts 130 is not limited, and the fitting parts 130 are formed at the right and the left to have elasticity near the pet's chest.

The cardiac massage part 140 includes a protrusion part 141 to massage in the vicinity of the left where the pet's heart is located, and gives massage to protect he pet's heart, and the cardiac massage part 140 has a cushioning feeling.

Additionally, an abdomen massage part 150 is formed at a part corresponding to the pet's abdomen and includes a protrusion part 151 to massage and protect the pet's abdomen, and the abdomen massage part 150 also has a cushioning feeling.

In this instance, the top of the pet clothing for body correction is made of a fiber material with elasticity, and parts excluding the spine protecting parts 110 and the spine fixing parts 120 are weaker in the degree of elasticity than the spine protecting parts 110 and the spine fixing parts 120.

In FIG. 3, the “S” part and the “S′” part indicated at the right and left sides of the pet clothing are folded in the arrow direction along the dotted lines 11 and 12, and are connected with each other to be formed integrally.

Referring to FIG. 3, spine protecting parts 110a and 110a formed at the right and the left near the pet's spine in order to protect the pet's spine have two or more spine fixing parts 120a and 120a formed at the right side of the spine protecting parts 110a and 110a and two or more spine fixing parts 120c and 120d formed at the left side of the spine protecting parts 110a and 110a so as to be extended from the front part 100a to the rear part 100a. Therefore, the spine fixing parts 110a and 110a fix the spine protecting parts 110a and 110a more securely.

Referring to FIGS. 6 to 12, the bottom of the pet clothing for surrounding the hind legs of the pet includes a tail part 210, knee protecting parts 220, hip joint parts 230, and a fixing part 240.

Referring to FIGS. 6 and 7, the tail part 210 is woven to open the tail and the hips of the pet and to have elasticity, so that the pets can easily pass urine and bowels.

The knee protecting parts 220 have a structure to press and fix the pet's knees in order to protect and correct dislocation of the kneepans of the hind legs of the pet, which easily slips on the slippery wooden floor or on the floor paper, and are formed in a diamond shape with elasticity.

In this instance, a plurality of the knee protecting parts 220 may be formed in a straight form, have an oval shape, and be formed in a shape to press the knees. The straight form may be formed in any desired direction, namely, horizontally or vertically.

The hip joint parts 230 are to protect both hip joint parts of the pet, and are formed in an ‘X’ shape using a fiber material with elasticity to prevent the hip joints from being twisted.

Additionally, the hip joint parts 230 are woven at portions corresponding to the pet's hip joints in the form that the number eight lies on the side in order to prevent the hip joints from being twisted. If portions are formed integrally with the hip joint parts to press the pet's hip joints more, it can prevent twisting of the hip joints more effectively.

The portions formed between the hip joint parts 230 to increase pressing effect may be formed in a straight line, but the shape is not limited.

The fixing part 240 is caught and fixed to the pet's waist in order to prevent the pet clothing from sliding down, and is woven to have elasticity.

In this instance, it is defined that the pet's waist is from the pet's abdomen to the tail, and the fixing part 240 is located at the pet's waist to prevent the pet clothing from sliding down.

Furthermore, the fixing part 240 may be woven in the form of braces to be fixed on the pet's body, and may be formed in one of various shapes.

The rest of the pet clothing excluding the knee protecting parts 220, the hip joint parts 230 and the fixing part 240 is formed integrally, and the pet clothing excluding the knee protecting parts 220, the hip joint parts 230 and the fixing part 240 are stronger in elasticity than the rest of the pet clothing. The knee protecting parts 220, the hip joint parts 230 and the fixing part 240 may be formed to have the equal degree or the different degree of elasticity.

Referring to FIGS. 10 and 11, the knee protecting parts and the hip joint parts will be described in detail as follows.

Referring to FIGS. 10 and 11, in order to prevent dislocation of the kneepan, knee protecting parts 220 of a diamond shape surrounding the pet's knees are formed at portions of the bottom of the pet clothing corresponding to the pet's hind legs.

When one of the knee protecting parts 220 is spread, the X-shape is connected to form the diamond shape at the center. Then, a user pulls the diamond shape to both sides so that the knee protecting parts 220 press the pet's knees not to be bent.

Moreover, the knee protecting parts 220 may be formed in a straight shape.

In this instance, the straight shape may be formed in a vertical direction or in a horizontal direction, and when the user pulls the straight shape to both sides, it presses the knees.

Furthermore, the knee protecting parts 220 may be formed in an oval shape.

In this instance, in order to press the oval shape strongly, a form to fix the oval shape at an upper portion and a lower portion may be formed integrally.

In order to prevent dislocation of the hip joints when the pet stands on hind legs or due to an abnormal posture, the hip joint parts 230 may be formed in an X shape at portions of the clothing corresponding to the pet's hip joints to press the pet's hip joints.

Additionally, the hip joint parts 230 may be formed at portions of the clothing corresponding to the pet's hip joints in the form that the number eight lies on the side. If the hip joint parts 230 are formed in the form that the number eight lies on the side, it can prevent the hip joints from being twisted, and if portions are formed integrally with the hip joint parts to press the pet's hip joints more, it can prevent twisting of the hip joints more effectively.

The portions formed between the hip joint parts 230 to increase pressing effect may be formed in a straight line, but the shape is not limited.

In this instance, the knee protecting parts 220 and the hip joint parts 230 are woven to have elasticity stronger than other parts of the clothing excluding the knee protecting parts 220 and the hip joint parts 230.

Moreover, In FIGS. 10 and 11, the “A” part and the “A′” part, the “B” part and the “B′” part, and the “C” part and the “C′” part indicated on the pet clothing are folded in the arrow direction along the dotted lines 11 and 12, and are connected with each other to be formed integrally.

Those skilled in the art will understand that the present invention can be implemented as other concrete forms without changing the inventive concept or essential features. Therefore, these embodiments as described above are only proposed for illustrative purposes and do not limit the present invention. It will be apparent to those skilled in the art that a variety of modifications and variations may be made without departing the spirit and scope of the present invention as defined by the appended claims. Further, such modifications and variations should not be understood independently from the technical idea or perspective of the present invention.

### Explanation of Reference Numerals in Drawings

| | |
|---|---|
| 100: Top | 110: Spine protecting part |
| 120: Spine fixing part | 130: Fitting part |
| 140: Cardiac massage part | 141: Protrusion part |
| 150: Abdomen massage part | 151: Protrusion part |
| 200: Bottom | 210: Tail part |
| 220: Knee protecting part | 230: Hip joint part |
| 240: Fixing part | |

1. A pet clothing for body correction that a pet wears to protect and correct the pet's spine, hip joints and kneepan from dislocation, the pet clothing for body correction, which is made of elastic materials and is divided into several parts with different degrees of elasticity, comprising:
a top for surrounding the pet's back and abdomen; and
a bottom for surrounding the pet's hind legs.

2. The pet clothing according to claim 1, wherein the top for surrounding the pet's back and abdomen comprising:
a front part for surrounding the pet's back; and a rear part for surrounding the pet's abdomen,
wherein when the pet wears the clothing, the front part includes: spine protecting parts formed at the right and the left on the basis of the spine in order to protect the pet's spine; and spine fixing parts formed adjacent to the spine protecting parts to pull the spine protecting parts to both sides and fix the spine protecting parts, and
wherein the other parts of the clothing excluding the spine protecting parts and the spine fixing parts are different in the degree of elasticity from the spine protecting parts and the spine fixing parts.

3. The pet clothing according to claim 2, wherein the top further comprises: a cardiac massage part formed on the rear part to protect the pet's heart; and a fitting part formed to allow the pet to put the forelegs into the fitting part, and
wherein the cardiac massage part is formed integrally and has a protrusion part to provide a cardiac massage function.

4. The pet clothing according to claim 3, wherein the top further comprises: an abdomen massage part formed on the rear part to protect the pet's abdomen, and
wherein the abdomen massage part is formed integrally, and has a protrusion part to provide an abdomen massage function.

5. The pet clothing according to claim 2, wherein the spine protecting parts are formed at the right and the left to be parallel with the pet's spine and to be spaced apart from each other at regular intervals on the basis of the pet's spine,
wherein the spine fixing parts extend from predetermined positions of the spine protecting parts to the rear part, and
wherein the fitting part made of the fiber material is formed at the rear part to have a shape for allowing the pet to put the forelegs thereinto.

6. The pet clothing according to claim 5, wherein other parts of the clothing excluding the spine protecting parts and the spine fixing parts are weaker in the degree of elasticity than the spine protecting parts and the spine fixing parts.

7. The pet clothing according to claim 6, wherein the predetermined positions where the spine fixing parts are formed are located at an upper end portion and a lower end portion on the basis of the central position in a longitudinal direction of the spine protecting parts.

8. The pet clothing according to claim 1, wherein the bottom for surrounding the pet's hind legs includes:
a tail part having an opening for allowing the pet to insert the tail thereinto; and
knee protecting parts for protecting the knee ligament by surrounding the knees of the hind legs of the pet, and
wherein other parts of the pet clothing excluding the knee protecting parts have different degrees of elasticity.

9. The pet clothing according to claim 1, wherein the bottom for surrounding the pet's hind legs comprises:
a tail part having an opening for passing the pet's tail therethrough; and
hip joint parts for surrounding the hip joints in order to protect the pet's hip joints, and
wherein other parts of the pet clothing excluding the hip joint parts have different degrees of elasticity.

10. The pet clothing according to claim 8, further comprising:
a fixing part caught and fixed to the pet's waist in order to prevent slip down of the clothing,
wherein the fixing part has elasticity.

11. The pet clothing according to claim 8, wherein the knee protecting parts are formed in a diamond shape to surround the knees of the hind legs of the pet, and when one of the knee protection parts is spread, an X-shape is connected to form the diamond shape at the center, and
wherein when a user pulls the diamond shape to both sides, the knee protecting parts press the pet's knees.

12. The pet clothing according to claim 11, wherein the knee protecting parts have a plurality of straight lines to surround the knees from knee parts of the hind legs, the straight lines are formed in a vertical direction or a horizontal direction, and
wherein when the user pulls the straight line shape to both sides, it presses the knees.

13. The pet clothing according to claim 9, wherein the hip joint parts are formed at portions of the clothing corresponding to the pet's hip joints in an X shape.

14. The pet clothing according to claim 8, wherein the knee protecting parts and the hip joint parts have the same degree of elasticity, and other parts of the clothing excluding the knee protecting parts and the hip joint parts are weaker in the degree of elasticity than the knee protecting parts and the hip joint parts.

15. The pet clothing according to claim 9, further comprising:
a fixing part caught and fixed to the pet's waist in order to prevent slip down of the clothing,
wherein the fixing part has elasticity.

16. The pet clothing according to claim 9, wherein the knee protecting parts and the hip joint parts have the same degree of elasticity, and other parts of the clothing excluding the knee protecting parts and the hip joint parts are weaker in the degree of elasticity than the knee protecting parts and the hip joint parts.
